(19) United States
(12) Patent Application Publication
(10) Pub. No.: US 2026/0073581 A1
(43) Pub. Date: Mar. 12, 2026

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventors: Kenji ISATAKE, Kanagawa (JP); Masakazu FUJIKI, Kanagawa (JP); Atsushi NOGAMI, Kanagawa (JP)

(21) Appl. No.: 19/316,010

(22) Filed: Sep. 2, 2025

(30) Foreign Application Priority Data
Sep. 10, 2024 (JP) 2024-156835

(51) Int. Cl. G06T 11/00; G06N 3/0475

(52) U.S. Cl. CPC G06T 11/00; G06N 3/0475

(57) ABSTRACT

An information processing apparatus comprising: a generation unit configured to acquire a generation result from source data using generative AI; a determination unit configured to determine information indicating a degree to which the generation result remains unchanged with respect to the source data based on information on the generative AI; and a recording unit configured to record the generation result and the information determined by the determination unit in association with each other.

### BACKGROUND

### Field of the Technology

The present disclosure relates to an information processing apparatus, a method of controlling the information processing apparatus, and a storage medium.

### Description of the Related Art

In recent years, with the spread of generative AI, an environment has been developed in which individuals can easily generate a large amount of a wide variety of data (text, image, moving image, audio, 3D model, and the like). Examples thereof include generation of news content and an AI newscaster that reports in a news program in the mass media industry, and generation of an AI celebrity, an AI actor, and the like in the entertainment industry. Data creation by such generative AI is considered to be further utilized in the future.

On the other hand, data generated by the generative AI may include information not factual or information greatly altered from a fact. In utilization of the generative AI data, it is necessary to correctly ascertain the state of such data and utilize the data.

In the description of US-2024-0073478, in order to determine whether a moving image has been edited, visual and audio features extracted by inputting a target video to a neural network are compared with features of a known video, thereby identifying and recording a source of the moving image.

However, in the technology of the description of US-2024-0073478, although the source of a generation result by generative AI is identified and recorded, "a degree indicating how factual the generation result by the generative AI is" or "a degree to which the generation result remains unchanged with respect to the source data" is not considered at all.

### SUMMARY

The present disclosure has been made in view of the above problems, and provides a technology for enabling confirmation of how factual a generation result by generative AI is, that is, how much the generation result remains unchanged with respect to the source data.

According to one aspect of the present disclosure, there is provided an information processing apparatus comprising: a generation unit configured to acquire a generation result from source data using generative AI; a determination unit configured to determine information indicating a degree to which the generation result remains unchanged with respect to the source data based on information on the generative AI; and a recording unit configured to record the generation result and the information determined by the determination unit in association with each other.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram illustrating an example of a use case of an information processing apparatus according to a first embodiment.

FIG. 2 is a block diagram illustrating a functional configuration of the information processing apparatus according to the first embodiment.

FIG. 3 is a block diagram illustrating a hardware configuration of the information processing apparatus according to the first embodiment.

FIG. 4 is a flowchart showing a flow of entire processing executed by the information processing apparatus according to the first embodiment.

FIG. 5 is a flowchart showing a flow of detailed processing for determining veracity information according to the first embodiment.

FIG. 6 is a view illustrating an example of a management table of veracity information and a model name used for determination processing of the veracity information according to the first embodiment.

FIG. 7 is a view illustrating an example of a data structure at the time of storing the veracity information according to the first embodiment.

FIG. 8 is a schematic diagram illustrating an example of a use case of an information processing apparatus according to a second embodiment.

FIG. 9 is a schematic diagram of the veracity information according to the first embodiment.

FIG. 10 is a schematic diagram of veracity information according to the second embodiment.

FIG. 11 is a view illustrating an example of a data structure at the time of storing the veracity information according to the second embodiment.

FIG. 12 is a schematic diagram of veracity information according to a third embodiment.

FIG. 13 is a schematic diagram illustrating an example of a use case of an information processing apparatus according to a sixth embodiment.

FIG. 14 is a flowchart showing a flow of entire processing executed by the information processing apparatus according to the sixth embodiment.

FIG. 15 is a flowchart showing a flow of detailed processing of a method of selecting a generation result based on veracity according to the sixth embodiment.

FIG. 16 is a view illustrating a display screen as an example of a notification unit according to a seventh embodiment.

FIGS. 17A and 17B are views illustrating modifications of a display screen as an example of the notification unit according to the seventh embodiment.

FIG. 18 is a block diagram illustrating a functional configuration of the information processing apparatus according to the sixth embodiment.

FIG. 19 is a block diagram illustrating a functional configuration of the information processing apparatus according to the seventh embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

First, an outline of an environment in which the information processing apparatus according to the first embodiment is used will be described. Here, "the degree indicating how factual a generation result by generative AI is" or "the degree to which the generation result remains unchanged with respect to the source data" is defined as "veracity". In the present embodiment, the veracity that is a degree indicating how factual a generation result by generative AI is (degree of factualness) is determined and recorded. In other words, the veracity is information indicating the degree to which the generation result by the generative AI remains unchanged with respect to the source data and the degree of retaining the feature for recognizing the original. Alternatively, in place of the veracity, information indicating the degree to which the generation result by the generative AI has changed with respect to the source data may be used. For example, if the user knows which part is factual with respect to a news moving image with an AI newscaster, the user can listen to the news moving image with the AI newscaster with a sense of security. In view of such a background, an attempt is made to provide a technology for keeping the veracity always in a confirmable state.

Generative AI processing in the present embodiment is two types of image processing: image generation AI processing by Inpainting and image quality enhancement processing of super-resolution. For each of the generation results of the two types of generative AI processing, the veracity of each is determined with the model information used for each generative AI processing as input, and the determined veracity is recorded for metadata of each generation result file. Here, the metadata is, for example, Exif of the image file.

A table for managing the veracity is used to determine the veracity using the model information used for the generative AI processing, and a detailed description will be given later. In this manner, the reason for obtaining the veracity from the model information used for the generative AI processing is that the alteration amount of the generative AI processing directly connected to the magnitude of the veracity is greatly affected by the model information.

For example, in Inpainting, the content different from the content of the source image is generated in a partial region, and thus the veracity is low. On the other hand, since the image quality enhancement processing of super-resolution is interpolation processing within a range in which the content of the source image remains unchanged, an image close to the fact is generated, and thus the veracity is high. In addition, in a case of the generative AI for style transfer, a large alteration is performed on the entire image with respect to the source image, and therefore it easily becomes far from the fact and the veracity is low. In this manner, since the model information and the veracity are strongly related, the veracity with respect to a generative AI result can be determined by using a table for managing predetermined veracity.

As described above, the veracity is information for ascertaining the degree of change from the source data by the generative AI. With reference to the veracity of data, the user of the generative AI data can use the data while avoiding data that greatly altered from the source data and including information that is not true. By associating the veracity with the metadata of a generation result file, the generation result and the veracity thereof can be easily confirmed. A method of determining the veracity and a method of recording will be described in detail later.

Note that the higher the numerical value of the veracity in the present embodiment is, the less an alteration from the source data is, and the information indicates that the degree of veracity is high, but the definition of the veracity is not limited to this. For example, conversely, the definition may indicate that the lower the numerical value of the veracity is, the smaller the degree of alteration is, and the closer the data is to the true data.

### Usage Form

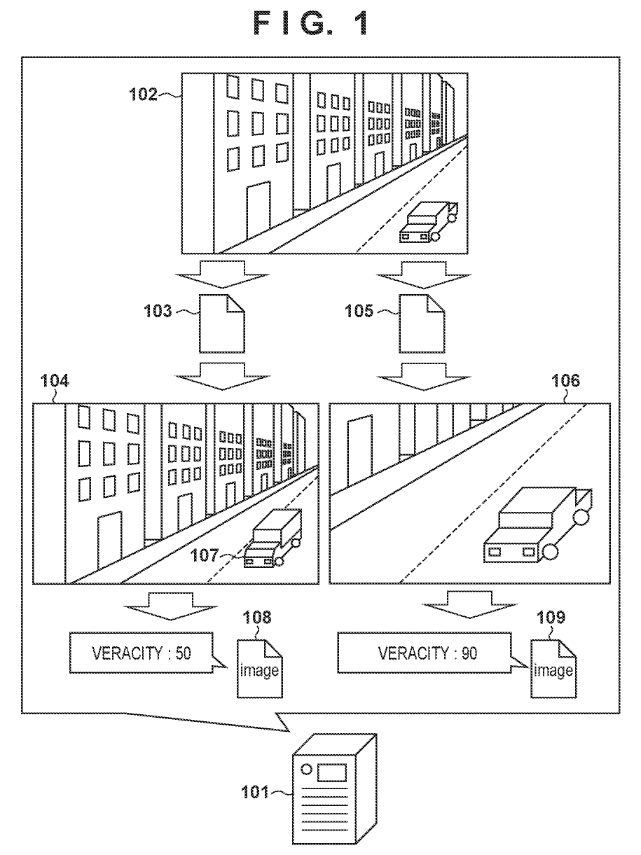

FIG. 1 is a schematic diagram illustrating an example of a use case of the information processing apparatus according to the first embodiment. FIG. 1 illustrates a situation of determining and recording the veracity of two image processing results of the image generation AI processing by Inpainting according to the present embodiment and the image quality enhancement processing of super-resolution. The determination and recording of the veracity are performed in a veracity recording apparatus 101. At this time, a source image 102 is subjected to two types of generative AI processing, and Inpainting image data 104 is generated by an Inpainting model A103, and super-resolution image data 106 is generated by a super-resolution model D105. Here, in the Inpainting image data 104, Inpainting processing in which a car appearing in the source image 102 is changed to a truck 107 is performed. The veracity obtained for the Inpainting image data 104 is recorded in an Inpainting image file 108. Similarly, the veracity obtained for the super-resolution image data 106 is recorded in a super-resolution image file 109.

### Functional Configuration

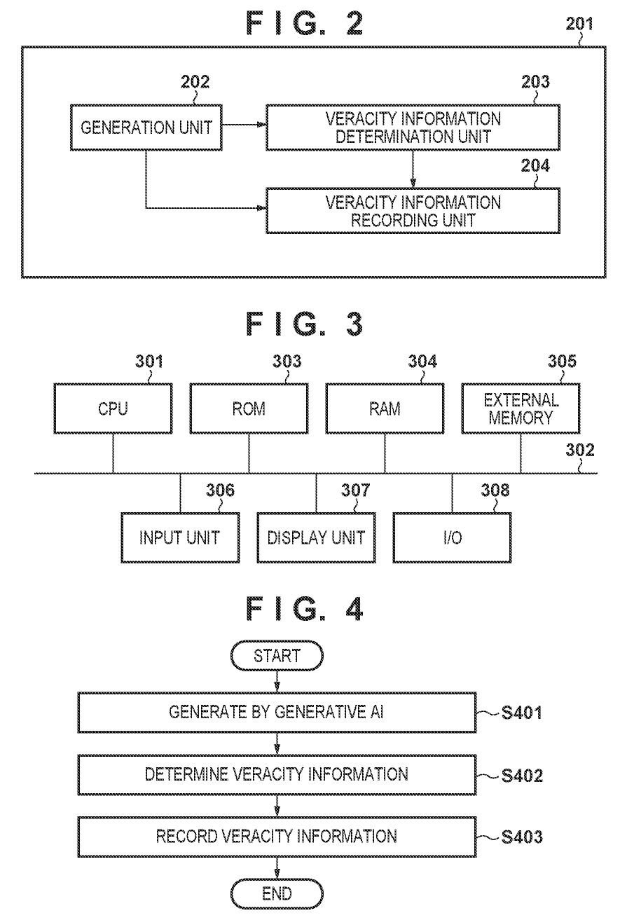

The configuration of the information processing apparatus according to the present embodiment will be described with reference to FIG. 2. FIG. 2 is a block diagram illustrating a functional configuration of the information processing apparatus according to the first embodiment. An information processing apparatus 201 includes a generation unit 202, a veracity information determination unit 203, and a veracity information recording unit 204. The information processing apparatus 201 operates in the veracity recording apparatus 101.

The generation unit 202 generates a generation result using generative AI processing. In the present embodiment, at least one of the Inpainting image data 104 or the super-resolution image data 106 is generated and acquired.

The veracity information determination unit 203 determines information regarding the veracity of the generation result based on the relationship between the information regarding the generative AI processing used by the generation unit 202 and the related veracity. In the present embodiment, the information regarding the generative AI processing is information regarding the Inpainting model A103 and the super-resolution model D105 used for the generative AI processing. Using this information, it is possible to determine the veracity of each of the Inpainting image data 104 or the super-resolution image data 106 generated by the generation unit 202.

The veracity information recording unit 204 records the information regarding the veracity in association with the generation result in the generation unit 202. In the present embodiment, the veracity of the Inpainting image data 104 determined by the veracity information determination unit 203 is stored in the Inpainting image file 108. Alternatively, the veracity of each of the super-resolution image data 106 is stored in the super-resolution image file 109. For example, the veracity of the Inpainting image data 104 and the veracity of the super-resolution image data 106 are stored in the metadata of the Inpainting image file 108 and the super-resolution image file 109, which are the respective image files.

### Hardware Configuration

FIG. 3 is a block diagram illustrating a hardware configuration of the information processing apparatus according to the first embodiment. The information processing apparatus 201 of FIG. 2 includes the hardware configuration illustrated in FIG. 3. A CPU 301 controls various devices connected to a bus 302 and executes information processing. CPU is an abbreviation for central processing unit. The bus 302 connects the CPU 301, a ROM 303, a RAM 304, and an external memory 305 in a manner that can communicate with one another.

The ROM 303 stores a BIOS program and a boot program. ROM is an abbreviation for read only memory. The RAM 304 is used as a main storage apparatus of the CPU 301. RAM is an abbreviation for random access memory. The external memory 305 stores a program to be processed by the information processing apparatus 201. An input unit 306 is a keyboard or a mouse, and performs processing related to input of information.

A display unit 307 outputs a calculation result of the information processing apparatus 201 to a display apparatus in accordance with an instruction from the CPU 301. Note that the display apparatus may be of any type, such as a liquid crystal display apparatus, a projector, or an LED indicator. LED is an abbreviation for light emitting diode. An image management server storing the source image 102 is connected to an I/O 308. I/O is an abbreviation for input/output.

### Processing Procedure and Detailed Method Of Processing

The processing procedure and the detailed method of processing of the information processing apparatus 201 according to the present embodiment will be described with reference to FIGS. 4 to 7.

FIG. 4 is a flowchart showing the flow of the entire processing executed by the information processing apparatus 201 illustrated in FIG. 2. In the present embodiment, the flowchart of FIG. 4 is started at the timing when the generative AI processing is started by the user.

In step S401, the generation unit 202 generates a generation result by the generative AI processing. In the present embodiment, the processing of applying the source image 102 with the Inpainting model A103 to generate the Inpainting image data 104, or the processing of applying the source image 102 with the super-resolution model D105 to generate the super-resolution image data 106 is performed.

In step S402, the veracity information determination unit 203 determines information regarding the veracity of the generation result based on the content of the generative AI processing used by the generation unit 202. In the present embodiment, the veracity of the image that is the generation result of the generation unit 202 is determined using the model information and a veracity management table used by the generation unit 202. Specifically, the veracity of the Inpainting image data 104 is determined using the information on the Inpainting model A103 and the veracity management table. Alternatively, the veracity of the super-resolution image data 106 is determined using the super-resolution model D105 and the veracity management table. One piece of veracity is determined for the entire image (entire region). A method of determining the veracity using the veracity management table will be described in detail later.

In step S403, the veracity information recording unit 204 records the information regarding the veracity in association with the generation result by the generation unit 202. In the present embodiment, the veracity of the Inpainting image data 104 is stored in a metadata part storing Exif information on the Inpainting image file 108. Alternatively, similarly, the veracity of each of the super-resolution image data 106 is stored in the metadata part storing Exif information on the super-resolution image file 109. The metadata part will be described in detail later.

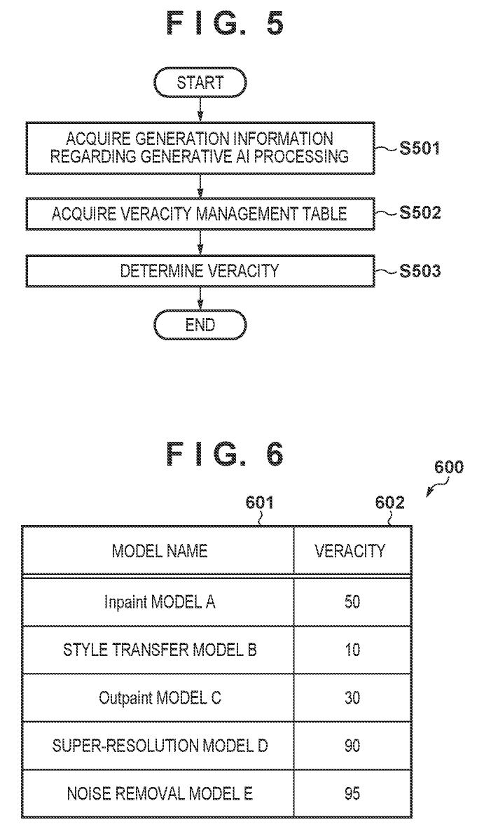

Next, a detailed method of determining the veracity will be described with reference to FIG. 5. FIG. 5 is a flowchart showing the flow of detailed processing of determining the veracity information performed in step S402 of FIG. 4.

In step S501, the veracity information determination unit 203 acquires generation information regarding the generative AI processing performed by the generation unit 202. In the present embodiment, the model name is acquired as the model information used in the generative AI processing. As a result, an "Inpainting model A", which is the model name of the Inpainting model A103, or a "super-resolution model D", which is the model name of the super-resolution model D105, is acquired.

In step S502, the veracity information determination unit 203 acquires a veracity management table. In this veracity management table, model information and the veracity of the generation result of the model are recorded in advance.

In step S503, the veracity information determination unit 203 determines the veracity of the generation result generated by the generation unit 202 based on the generation information related to the generative AI processing and the veracity management table. Since the model name and the veracity of the generation result of the model are recorded in the veracity management table acquired in step S502, corresponding veracity is referred to with the model name used for the generative AI processing acquired in step S501 as input. The reference result thereof is determined as the veracity of the generation result. In this manner, by referring to the table in which the model information and the veracity are associated with each other, it is possible to estimate the magnitude of the veracity caused by the alteration amount of the generative AI processing different depending on the generative AI model. Here, the veracity management table will be described in detail later with reference to FIG. 6.

### Example of Veracity Management Table

Next, the veracity management table in the present embodiment will be described with reference to FIG. 6. FIG. 6 is a schematic diagram of a veracity management table 600 used in step S402 of FIG. 4 and steps S502 and S503 of FIG. 5.

In the veracity management table 600, two items of a "model name 601" and "veracity 602" are described. As described above, this "veracity 602" is the veracity of the generation result of the model described in the "model name 601". Specifically, this indicates that the generation result generated using the model described in the "model name 601" is approximately the veracity described in the "veracity 602". Referring to FIG. 6 in detail indicates that the veracity 602 of the model of the "Inpainting model A" is "50". In addition, it is indicated that the veracity 602 of the model of a "style transfer model B" is "10", and the veracity 602 of the model of an "Outpainting model C" is "30". It is indicated that the veracity 602 of the model of the "super-resolution model D" is "90", and the veracity 602 of the model of a "noise removal model E" is "95".

As described in this table, the veracity is set to be low for the processing of a type of rewriting an image itself such as style transfer, Inpainting, and Outpainting. On the other hand, the veracity is set to be high for the image quality enhancement processing of super-resolution and noise removal because the image quality enhancement processing is merely performed without changing the content itself of the subject. By referring to this table, it is indicated that the veracity of the Inpainting image data 104 generated by applying the Inpainting model A103 is "50". It is indicated that the veracity of the super-resolution image data 106 generated by applying the super-resolution model D105 is "90".

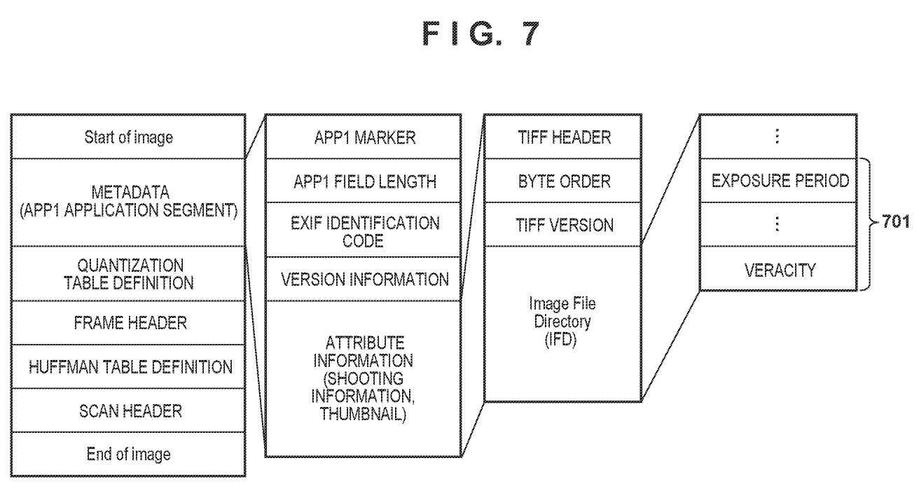

Hereinafter, a detailed method of recording the veracity in the present embodiment will be described with reference to FIG. 7. FIG. 7 is an example of the data structure of the metadata of an image file recording the veracity. FIG. 7 is a view of the data structure of a JPEG file. In the data structure, a metadata part 701 indicating a part storing Exif stores information on the veracity.

### Effect

As described above, according to the present embodiment, it is possible to confirm the veracity indicating how factual a generation result by generative AI is. Therefore, the data of the generation result can be used while confirming the veracity, and the data can be used with a sense of security while ascertaining the degree of factualness.

### Modification: Variation of Generation Result

In the first embodiment, an example in which the generation result of the generative AI is an image has been described, but the generation result is not limited to an image as long as the veracity can be recorded in metadata. For example, the generation result of the generative AI may be a moving image or an audio, and the veracity may be recorded in metadata of a moving image or audio information converted into a file. This can determine and record the veracity described in the present embodiment regardless of the data form of the generation result of the generative AI processing.

### Modification: Encryption

In the first embodiment, the veracity information is directly recorded in the metadata without additional processing performed thereon, but it may be recorded after the additional processing is performed as long as the veracity information can be recorded in a state where the veracity can be browsed. For example, the veracity information may be encrypted and recorded so that the veracity cannot be altered. Supplementary information on the veracity (time information at which the processing by the generative AI was executed, an execution history of the processing by the generative AI, information indicating a determination basis or definition of the veracity, and the like) may be encrypted and recorded. That is, at least one of the veracity and the supplementary information on the veracity may be encrypted and recorded. This can record the information regarding the veracity regardless of the data form of the veracity to be recorded in the metadata.

### Modification: Variation of Item to be Registered in Veracity Management Table

In the first embodiment, the model name is described in the veracity management table as an item related to the veracity, but other content may be described in the veracity management table as long as the item affects the veracity and is related to the generative AI. For example, the editing content of the generative AI, the setting parameter used in the generative AI processing, and prompt content may be used.

In the first embodiment, only the item regarding the veracity and the generative AI processing is described in the veracity management table, but other items may be additionally described as long as the veracity can be referred to. For example, a plurality of items of the model name, the setting parameter used in the generative AI processing, the editing content of the generative AI, and the prompt content may be described.

This can determine and record the information on the veracity with reference to the veracity management table based on information other than the model name.

### Modification: Variations of Image Quality Enhancement Processing and Generative AI Processing

In the first embodiment, the super-resolution processing has been described as the image quality enhancement processing, but another type of processing may be used as long as it is a method of image processing using a model. For example, it may be noise removal processing, demosaic processing, or aberration correction processing.

In the first embodiment, the Inpainting processing has been described as an example of the generative AI processing, but another type of processing may be used as long as it is generative AI processing using a model. For example, it may be style transfer, Outpainting, or image synthesis processing.

This can perform determination of the veracity and recording processing regardless of the type of the generative AI processing.

### Modification: Variation of Data Structure

In the first embodiment, an example of the format of the JPEG file has been described with reference to FIG. 7 as an example of the data structure of the metadata of the image file recording the veracity. However, as long as the veracity can be stored in the metadata of the generation result file, a format other than the JPEG file may be used. For example, the file format may be PNG or TIFF. This can record the veracity in the metadata regardless of the format of the image file.

### Second Embodiment

In the first embodiment, a method of determining and recording, in the metadata of the generation result file, the veracity based on the veracity management table and the information regarding the generative AI processing has been described. In the present embodiment, a method of determining and recording, in the metadata of the generation result file, the veracity by comparison between the source data before the generative AI processing is performed and the generated data after the generative AI processing will be described.

Specifically, as described later, the veracity is determined based on the similarity between the source data on which the generative AI processing is not executed and the data after the generative AI processing. The reason for calculating the similarity using the source data before the generative AI processing is performed is that the degree of factualness can be evaluated as a degree similar to the source data before the generative AI processing is performed. This can determine the veracity of the generated data even in a situation where a corrected region by the generative AI and an uncorrected region are mixed in the generated data by the generative AI.

### Usage Form

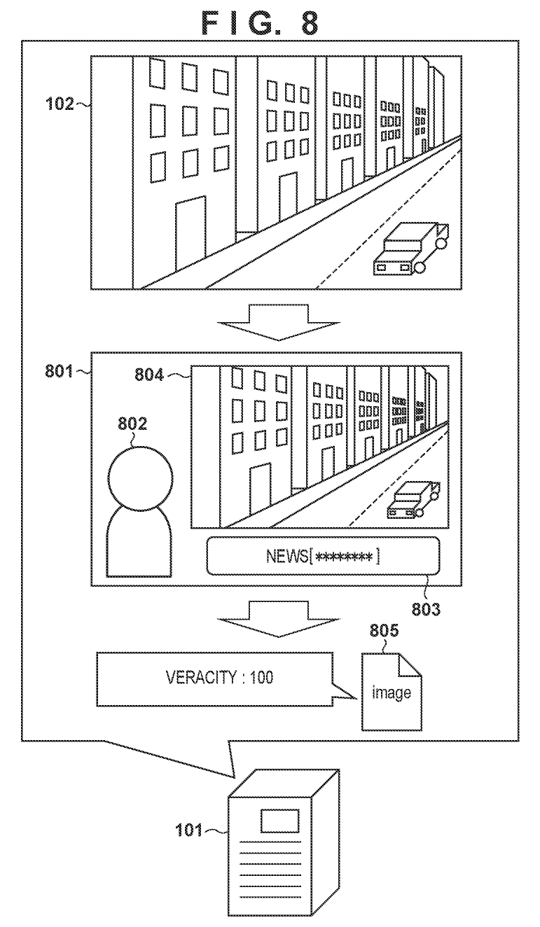

FIG. 8 is a schematic diagram illustrating an example of a use case of the information processing apparatus in the second embodiment. FIG. 8 illustrates a situation where the veracity is determined and recorded for news image data 801 created by the generative AI processing according to the present embodiment. Similarly to the first embodiment, the determination and recording of the veracity are performed in the veracity recording apparatus 101. At this time, an AI newscaster 802 and a caption 803 are added by the generative AI processing with the source image 102 as input, and the news image data 801 in which the image of the source image 102 is embedded in a region of 804 is generated as a news image. Then, the veracity determined for the news image data 801 is recorded in a news image file 805.

### Functional Configuration

The configuration of the information processing apparatus according to the second embodiment will be described with reference to FIG. 2. Similarly to the first embodiment, the information processing apparatus 201 according to the second embodiment includes the generation unit 202, the veracity information determination unit 203, and the veracity information recording unit 204.

Similarly to the first embodiment, the generation unit 202 generates a generation result by generative AI processing. In the present embodiment, the news image data 801 is generated. The veracity information determination unit 203 determines information regarding the veracity of the generation result based on the information regarding the generative AI processing used in the generation unit 202. In the present embodiment, the information regarding the generative AI processing is the source image 102, which is an image before the generative AI processing. Use of the source image 102 enables the veracity to be determined for each partial region with respect to the news image data 801 generated by the generation unit 202.

Similarly to the first embodiment, the veracity information recording unit 204 records information regarding the veracity in association with the generation result in the generation unit 202. In the present embodiment, the veracity of each partial region in the news image data 801 and the partial region information thereof are recorded in the metadata of the news image file 805.

### Hardware Configuration

Since the hardware configuration of the information processing apparatus 201 according to the second embodiment is similar to that in FIG. 3, the description thereof will be omitted.

### Processing Procedure and Detailed Method Of Processing

The processing procedure and the detailed method of processing of the information processing apparatus 201 according to the present embodiment will be described with reference to FIGS. 4 and 9 to 11. FIG. 4 is a flowchart showing the flow of the entire processing to be executed by the information processing apparatus 201 in the present embodiment, similarly to the first embodiment.

In step S401, the generation unit 202 generates a generation result by the generative AI processing. In the present embodiment, the news image data 801 is generated using the source image 102.

In step S402, the veracity information determination unit 203 determines information regarding the veracity of the generation result based on the image before the generative AI processing performed by the generation unit 202. In the present embodiment, the similarity between the source image 102 used in the generative AI processing and each partial region of the news image data 801 that is the generation result is calculated, and the similarity is determined as the veracity, and the detailed processing will be described later.

In step S403, the veracity information recording unit 204 records the information regarding the veracity in association with the generation result by the generation unit 202. In the present embodiment, the veracity of each partial region in the news image data 801 and coordinate information that is the partial region information thereof are recorded in the metadata part storing Exif information on the news image file 805. The metadata part will be described in detail later.

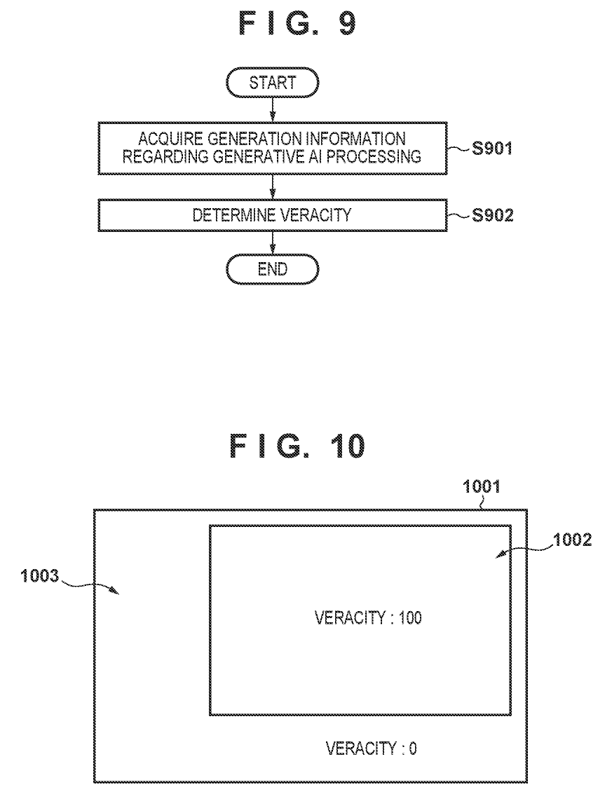

Subsequently, a detailed method of determining the veracity in the present embodiment will be described with reference to FIG. 9. FIG. 9 is a flowchart showing the flow of the detailed processing of determining the veracity information performed in step S402 of FIG. 4 in the present embodiment.

In step S901, the veracity information determination unit 203 acquires generation information regarding the generative AI processing performed by the generation unit 202. In the present embodiment, the source image 102 used in the generative AI processing is acquired.

In step S902, the veracity information determination unit 203 calculates the similarity between the source image 102 and each partial region of the news image data 801, and determines the similarity as the veracity. Specifically, the source image 102 is reduced to generate a reference image, and the similarity is calculated for each partial region in the news image data 801 using the reference image. The similarity calculated here may be, for example, known template matching. Since the similarity for each partial region is output by this similarity calculation processing, the value is determined for each partial region as the veracity. A detailed similar result at this time will be described later with reference to FIG. 10.

Hereinafter, a schematic diagram of the veracity information determined in the present embodiment will be described with reference to FIG. 10. FIG. 10 is a schematic diagram illustrating a calculation result of the similarity between the source image 102 and each partial region of the news image data 801 determined in the present embodiment. There is a first partial region 1002 having a high similarity to the source image 102 with respect to an entire region 1001 having the same size as the news image data 801. The first partial region 1002 is a region where the similarity is 1, which is the maximum when the value ranges from 0 to 1. Therefore, the veracity of the first partial region 1002 is 100, which is the maximum. On the other hand, a second partial region 1003 having a low similarity to the source image 102 has the minimum similarity of 0, and thus has the lowest veracity of 0.

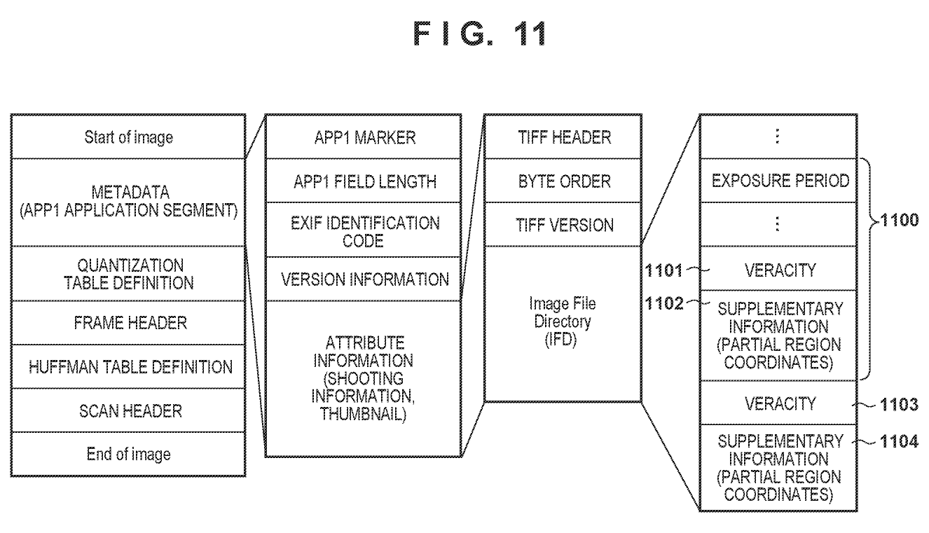

Next, a detailed method of recording the veracity in the present embodiment will be described with reference to FIG. 11. FIG. 11 is an example of the data structure of the metadata of an image file recording the veracity in the present embodiment. FIG. 11 illustrates a data structure of a JPEG file similarly to the first embodiment. In the data structure, a metadata part 1100 indicating a part storing Exif stores information on the veracity and the like. In the present embodiment, the veracity for each partial region and the partial region information thereof are stored altogether. Specifically, the veracity of the first partial region 1002 is recorded in a region 1101, and the coordinate information on the first partial region 1002 is recorded in a region 1102. Similarly, the veracity of the second partial region 1003 is recorded in a region 1103, and the coordinate information on the second partial region 1003 is recorded in a region 1104. If there are other partial regions, they may be recorded similarly.

### Effect

As described above, according to the present embodiment, it is possible to confirm the veracity indicating how factual a generation result by generative AI is for each partial region of the generation result.

### Modification: Variation of Calculation Target of Similarity and Veracity

In the present embodiment, the similarity and the veracity are determined for each partial region in the generation result, but the present disclosure is not limited to this as long as the veracity of the generation result can be determined. For example, the similarity may be calculated for the entire generated image to obtain the veracity. The veracity may be determined for each pixel. This can determine the veracity for various targets.

### Modification: Variation of Method of Comparing with Source Image

In the present embodiment, the similarity between the source image 102 and the news image data 801 that is a generation result is determined as the veracity, but another comparison result between the source image 102 and the news image data 801 may be used for determination of the veracity. For example, the similarity may be a similarity of an edge image between the source image 102 and the news image data 801 or a similarity of an image processing result in consideration of a color difference. Alternatively, it may be an image quality evaluation index of a mean square error (MSE), a peak signal to noise ratio (PSNR), or a structural similarity (SSIM). This can determine the veracity regardless of the method of comparing between the source image and the generation result image.

### Modification: Variation of Method of Recording Veracity

In the present embodiment, the veracity is recorded in the metadata storing Exif information on the image file, but the veracity may be recorded in another form as long as it can be recorded in association with the image data. For example, a veracity map describing the veracity in the first partial region 1002 and the veracity in the second partial region 1003 as illustrated in FIG. 10 may be recorded in a display form as in FIG. 10, and may be stored as image data in an extension channel of the image data. This can record the image data and the veracity in a browsable state regardless of the method of recording the veracity.

### Modification: Variation of Information to be Recorded Together with Veracity

In the present embodiment, the veracity and the partial region information are recorded in association with each other in the metadata of the generation result file, but the veracity may be recorded in association with other information as long as the information is related to the veracity. For example, supplementary information such as editing content by the generative AI processing, an editing history, an execution history, time information or date and time information at which the veracity was determined, definition information on the veracity, or information indicating a determination basis of the veracity may be stored in association with the veracity. Alternatively, at least one piece of supplementary information among the time information at which the processing by the generative AI was executed, the execution history of the processing by the generative AI, and the information indicating the determination basis or definition of the veracity may be recorded in association with the veracity.

This can record the veracity for each executed generative AI processing in a case where the editing content or the editing history of the generative AI processing is associated, and therefore it is possible to confirm history information such as transition of the veracity corresponding to transition of the generative AI processing by confirming the metadata. In a case where the time information and the date and time information at which the veracity was determined are associated, it is possible to confirm the veracity at what point in time. For example, in a case where a subject (e.g., a building) of a part of an image is deleted by generative AI image processing, and in a case where the subject (building) is subsequently demolished also in reality, the veracity varies depending on the date and time. In that case, by confirming the metadata, it is possible to recognize the veracity at what point in time. In a case where the definition information and the determination basis of the veracity are associated, it is possible to recognize what veracity is being handled by checking the metadata. According to this modification, it is possible to record, in the metadata, the veracity and supplementary information related thereto, regardless of the form of information to be associated with the veracity.

### Third Embodiment

In the first embodiment and the second embodiment, an example in which the veracity is determined by the veracity management table or by comparison with the source image such as the similarity with the source image, and recorded in the metadata of the generation result file has been described.

On the other hand, in the present embodiment, an example in which the veracity is determined based on the change content of the generation result data by the generative AI processing and recorded in the metadata of the generation result file will be described. Specifically, as described later, the veracity is determined based on the ratio of the edited region between the source image and the generation result image. Use of an editing area ratio by the generative AI processing enables an "alteration amount by the generative AI" to be calculated as an index corresponding to a "change amount indicating that what was based on a fact is no longer based on the fact", and this can be determined as the veracity. This can determine and record the veracity of the generation result data if the change amount of the edited region by the generative AI processing is known.

### Usage Form

The use case in the third embodiment is similar to FIG. 1, which is the use case of the first embodiment, and thus the description thereof will be omitted.

### Functional Configuration

The configuration of the information processing apparatus according to the third embodiment will be described with reference to FIG. 2. Similarly to the first embodiment, the information processing apparatus 201 according to the third embodiment includes the generation unit 202, the veracity information determination unit 203, and the veracity information recording unit 204. Note that the functions of the generation unit 202 and the veracity information recording unit 204 are similar to those of the first embodiment, and thus description thereof will be omitted.

The veracity information determination unit 203 determines information regarding the veracity of the generation result based on the information regarding the generative AI processing used in the generation unit 202. In the present embodiment, the information regarding the generative AI processing is the source image 102, which is an image before the generative AI processing, and the Inpainting image data 104, which is a generation result image. Using these two types of images, the veracity is determined for the generation result (the Inpainting image data 104) in the generation unit 202.

### Hardware Configuration

Since the hardware configuration of the information processing apparatus 201 according to the third embodiment is similar to that in FIG. 3, the description thereof will be omitted.

### Processing Procedure and Detailed Method Of Processing

The processing procedure and the detailed method of processing of the information processing apparatus 201 according to the present embodiment will be described with reference to FIGS. 4, 7, 9, and 12. FIG. 4 is a flowchart showing the flow of the entire processing to be executed by the information processing apparatus 201 in the present embodiment, similarly to the first embodiment and the second embodiment. Note that processing in steps S401 and S403 is similar to that in the first embodiment, and thus description thereof will be omitted.

In step S402, the veracity information determination unit 203 determines information regarding the veracity of the generation result based on the image before the generative AI processing performed by the generation unit 202. In the present embodiment, the editing area ratio that is the ratio of the edited region by the generative AI processing is calculated from the source image 102 used in the generative AI processing of the generation unit 202 and the Inpainting image data 104, which is the generation result image. The determination of the veracity using the editing area ratio will be described in detail later.

Subsequently, a detailed method of determining the veracity in the present embodiment will be described with reference to FIG. 9. FIG. 9 is a flowchart showing the flow of the detailed processing of determining the veracity information performed in step S402 of FIG. 4 according to the present embodiment. Note that step S901 is similar to that of the second embodiment, and thus description thereof will be omitted.

In step S902, the veracity information determination unit 203 calculates the editing area ratio between the source image 102 and the Inpainting image data 104, which is the generation result, and determines the area ratio as the veracity. Specifically, since the edited region in the Inpainting image data 104 is only the region of the truck 107, the editing area ratio can be calculated by "(region area of the truck 107)/(entire area of the Inpainting image data 104) × (100)". Thereafter, a value in which the editing area ratio is subtracted from the maximum veracity 100 is determined as the value of the veracity. A specific schematic diagram of the editing area ratio will be described later.

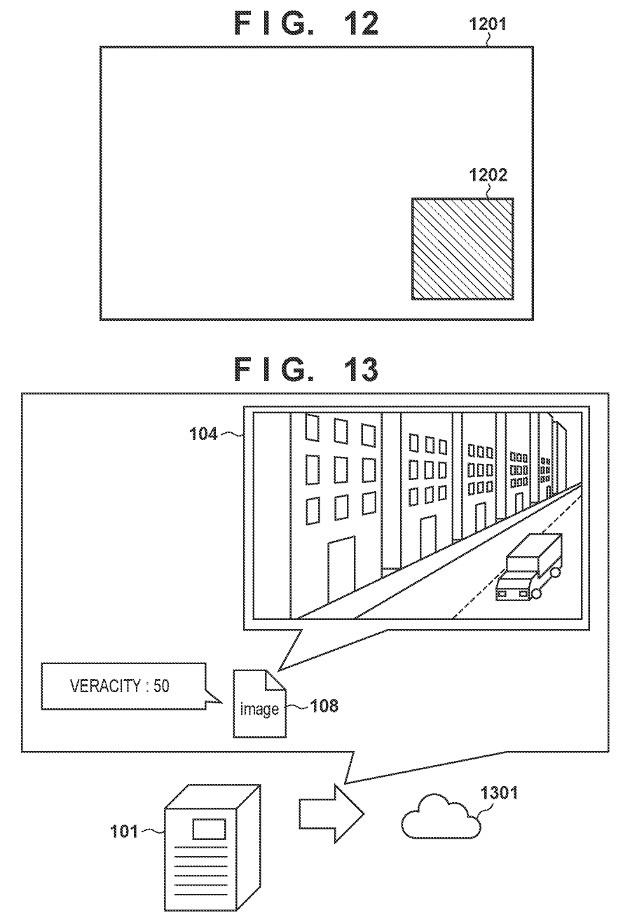

Hereinafter, a schematic diagram of the veracity information determined in the present embodiment will be described with reference to FIG. 12. FIG. 12 is a schematic diagram of an editing area calculated based on the source image 102 and the Inpainting image data 104, which is the generation result. For an entire image region 1201 having the same size as that of the Inpainting image data 104, a region edited by the generative AI processing is an edited region 1202. The edited region 1202 is a region corresponding to the truck 107 in the Inpainting image data 104. In a case where the edited region 1202 is 5% with respect to the entire image region 1201, the veracity of the Inpainting image data 104 is maximum veracity "100" (unit: %) - editing area ratio "5" (unit: %) = 95.

The description of a detailed method of recording the veracity in the present embodiment is similar to that of FIG. 7 described in the first embodiment, and thus is omitted.

### Effect

As described above, according to the present embodiment, it is possible to determine and record the veracity of the generation result by the generative AI in a situation where the editing area ratio by the generative AI processing is known.

### Fourth Embodiment

In the first embodiment to the third embodiment, an example in which the veracity is determined by the veracity management table or by comparison with the source image such as the similarity with the source image or the editing area ratio, and recorded in the metadata of the generation result file has been described.

On the other hand, in the present embodiment, an example in which the veracity is determined based on the setting parameter value used in the generative AI processing and recorded in the metadata of the generation result file will be described. Specifically, as described later, the veracity is determined based on a setting parameter for adjusting the reflection rate of a generation condition (hereinafter, a prompt) used in the generative AI processing. Since the reflection rate of the prompt is a parameter indicating the degree to which the prompt is reflected in the source image, the editing amount by the generative AI processing increases as the prompt is reflected. As a result, since the degree of factualness also decreases, the setting parameter value (e.g., the setting parameter value for adjusting the prompt reflection rate) for determining the editing amount by the generative AI processing is used for determination of the veracity.

### Usage Form

A use case of the information processing apparatus according to the fourth embodiment will be described with reference to FIG. 1. In the fourth embodiment, similarly to the first embodiment, the Inpainting image data 104 and the super-resolution image data 106 are generated by subjecting the source image 102 to the generative AI processing. The prompts used for generation of these generation results are an Inpainting prompt 103 and a super-resolution prompt 105. The Inpainting prompt 103 describes the content of "truck, nighttime". The super-resolution prompt 105 describes the content of "super-resolution by enlarging the vehicle part".

### Functional Configuration

The configuration of the information processing apparatus according to the fourth embodiment will be described with reference to FIG. 2. Similarly to the first embodiment, the information processing apparatus 201 according to the fourth embodiment includes the generation unit 202, the veracity information determination unit 203, and the veracity information recording unit 204. Note that the functions of the generation unit 202 and the veracity information recording unit 204 are similar to those of the first embodiment, and thus description thereof will be omitted.

The veracity information determination unit 203 determines information regarding the veracity of the generation result based on the information regarding the generative AI processing used in the generation unit 202. In the present embodiment, the information regarding the generative AI processing is a setting parameter of the prompt reflection rate used for the generative AI processing. For example, it is a parameter called a CFG scale in stable diffusion. Using the setting parameter of the prompt reflection rate, the veracity is determined for the generation result (the Inpainting image data 104 and the super-resolution image data 106) in the generation unit 202.

### Hardware Configuration

Since the hardware configuration of the information processing apparatus 201 according to the fourth embodiment is similar to that in FIG. 3, the description thereof will be omitted.

Processing Procedure and Detailed Method Of Processing

The processing procedure and the detailed method of processing of the information processing apparatus 201 according to the present embodiment will be described with reference to FIGS. 4, 7, and 9. FIG. 4 is a flowchart showing the flow of the entire processing to be executed by the information processing apparatus 201 in the present embodiment, similarly to the first embodiment to the third embodiment. Note that processing in steps S401 and S403 is similar to that in the first embodiment, and thus description thereof will be omitted.

In step S402, the veracity information determination unit 203 determines information regarding the veracity of the generation result based on the image before the generative AI processing performed by the generation unit 202. In the present embodiment, the veracity is determined based on the setting parameter of the prompt reflection rate used in the generative AI processing executed by the generation unit 202. The determination of the veracity using the prompt reflection rate will be described in detail later.

Subsequently, a detailed method of determining the veracity in the present embodiment will be described with reference to FIG. 9. FIG. 9 is a flowchart showing the flow of the detailed processing of determining the veracity information performed in step S402 of FIG. 4 according to the present embodiment.

In step S901, the veracity information determination unit 203 acquires generation information regarding the generative AI processing performed by the generation unit 202. In the present embodiment, the prompt reflection rate of the Inpainting prompt 103 or the super-resolution prompt 105 used in the generative AI processing is acquired.

In step S902, the veracity information determination unit 203 determines the veracity based on the setting parameter of the prompt reflection rate used in the generative AI processing. Here, the prompt reflection rate of the Inpainting prompt 103 is "50". It is a half value because the maximum value of the prompt reflection rate is 100. This indicates that only the half of the words "truck" of the words "truck, nighttime" described in the Inpainting prompt 103 is reflected in the generation of the Inpainting image data 104.

As a result, the veracity of the Inpainting image data 104 is determined as (maximum value of the reflection rate "100") - (prompt reflection rate "50" of the Inpainting prompt 103) × (prompt coefficient "1") = 50. Here, the reason why the prompt coefficient in the case of the Inpainting image data 104 is "1", which is the maximum value, is that the Inpainting processing of the generative AI processing content greatly changes the degree of factualness.

Similarly, the prompt reflection rate of the super-resolution prompt 105 is "100", and the maximum value is set for the reflection rate. Here, since the super-resolution prompt 105 has the content of "super-resolution by enlarging the vehicle part", it is indicated that the entire prompt content has been reflected. As a result, the veracity of the super-resolution image data 106 is determined as (maximum value of the reflection rate "100") - (prompt reflection rate "100" of the super-resolution prompt 105) × (prompt coefficient "0.1") = 90. Here, the reason why the prompt coefficient in the case of the super-resolution image data 106 is a low value of "0.1" is that the generative AI processing content is image quality enhancement called super-resolution, and the image quality enhancement processing itself does not greatly change the degree of factualness in the first place.

In another example, it is considered a case where the prompt is three words of "cat, crouching, black", two words of "cat, crouching" are reflected in the generation result, and one word of "black" is not reflected. The prompt reflection rate at this time is "66.7 (= 100 × 2/3)". In this case, the veracity of the Inpainting image data 104 can be determined as (maximum value of the reflection rate "100") - (prompt reflection rate "66.7" of the Inpainting prompt 103) × (prompt coefficient "1") = 33.4.

The description of a detailed method of recording the veracity in the present embodiment is similar to that of FIG. 7 described in the first embodiment, and thus is omitted.

### Effect

As described above, according to the present embodiment, it is possible to determine and record the veracity of the generation result by the generative AI in a situation where the setting parameter of the generative AI processing is known.

### Modification: Variation of Setting Parameter

In the fourth embodiment, the prompt reflection rate has been described as an example of the setting parameter used in the generative AI, but another parameter may be used as long as the setting parameter can determine the veracity. For example, an intensity parameter for image quality enhancement such as denoise intensity may be used. In addition, a reflection degree of a style of another image used in style transfer processing of reflecting the style of the other image with respect to the source image may be used. This can determine and record the veracity regardless of the form of the setting parameter.

### Modification: Variations of Image Quality Enhancement Processing and Generative AI Processing

In the present embodiment, the Inpainting processing has been described as the generative AI processing, and the super-resolution processing has been described as the image quality enhancement processing, but another method of image processing may be used as long as the image processing is performed using a prompt. For example, similarly to the first embodiment, noise removal processing, demosaic processing, or aberration correction processing may be performed as the image quality enhancement processing. Style transfer, Outpainting, or image synthesis processing may be performed as the generative AI processing. This can perform determination of the veracity using the setting parameter and recording processing regardless of the form of the generative AI processing including the image quality enhancement processing.

### Fifth Embodiment

In the first to fourth embodiments, an example in which the veracity is directly determined and recorded in the metadata of the generation result file has been described. On the other hand, in the present embodiment, an example in which information for analogizing the veracity is determined and recorded in the metadata of the generation result file will be described.

Specifically, as described later, the prompt information used in the generative AI processing is determined and recorded as the information regarding the veracity. By recording the prompt in the metadata of the generation result image, the user who confirms the image can acquire the prompt information from the metadata and confirm the content. As a result, the content of the source image or the generative AI processing content can be estimated from the prompt content, and the veracity can be estimated, and therefore in the present embodiment, the prompt information is determined and recorded as the information regarding the veracity.

### Usage Form

The use case in the fifth embodiment is similar to the use case in the fourth embodiment, and thus the description thereof will be omitted.

### Configuration

The configuration of the information processing apparatus according to the fifth embodiment will be described with reference to FIG. 2. Similarly to the first embodiment, the information processing apparatus 201 according to the fifth embodiment includes the generation unit 202, the veracity information determination unit 203, and the veracity information recording unit 204. Note that the generation unit 202 is similar to that of the first embodiment, and thus description thereof will be omitted.

The veracity information determination unit 203 determines information regarding the veracity of the generation result based on the information regarding the generative AI processing used in the generation unit 202. In the present embodiment, the information regarding the generative AI processing is a prompt used by the generation unit 202. This prompt information is determined as information regarding the veracity.

The veracity information recording unit 204 records the information regarding the veracity in association with the generation result in the generation unit 202. In the present embodiment, the prompt information used by the generation unit 202 is stored in the metadata of the generated image file.

### Hardware Configuration

Since the hardware configuration of the information processing apparatus 201 according to the fifth embodiment is similar to that in FIG. 3, the description thereof will be omitted.

### Processing Procedure and Detailed Method Of Processing

The processing procedure and the detailed method of processing of the information processing apparatus 201 according to the present embodiment will be described with reference to FIGS. 4 and 7. FIG. 4 is a flowchart showing the flow of the entire processing to be executed by the information processing apparatus 201 in the present embodiment, similarly to the first embodiment to the fourth embodiment. Note that step S401 is similar to that of the first embodiment, and thus description thereof will be omitted.

In step S402, the veracity information determination unit 203 determines information regarding the veracity of the generation result based on the image before the generative AI processing performed by the generation unit 202. In the present embodiment, the prompt information used by the generation unit 202 is determined as the veracity. Specifically, in the case of the Inpainting image data 104, the Inpainting prompt 103 is determined as the information regarding the veracity. Alternatively, in the case of the super-resolution image data 106, the super-resolution prompt 105 is determined as the information regarding the veracity.

In step S403, the veracity information recording unit 204 records the information regarding the veracity in association with the generation result by the generation unit 202. In the present embodiment, in the case of the Inpainting image data 104, the description content of the Inpainting prompt 103 is stored in the metadata part storing Exif information of the Inpainting image file 108. Alternatively, in the case of the super-resolution image data 106, the super-resolution prompt 105 is stored in the metadata part storing Exif information of the super-resolution image file 109. The metadata part will be described in detail later.

Subsequently, a detailed method of recording information regarding the veracity in the present embodiment will be described with reference to FIG. 7. FIG. 7 is an example of the data structure of metadata of an image file in which information regarding the veracity is recorded. FIG. 7 is a view of the data structure of the JPEG file as described above. In the present embodiment, the prompt information is stored as the information regarding the veracity in the metadata part 701 of the part storing Exif. In the case of the Inpainting image data 104, the content of the Inpainting prompt 103 is stored. Alternatively, in the case of the super-resolution image data 106, the content of the super-resolution prompt 105 is stored.

### Effect

As described above, according to the present embodiment, it is possible to determine and record the information regarding the veracity of the generation result by the generative AI in a situation where there is a prompt used for the generative AI processing.

### Modification: Variation of Information Regarding Veracity

In the present embodiment, the prompt has been described as an example of the information regarding the veracity, but other information may be used as long as the information is used to analogize the veracity. For example, it may be the veracity of the input data used for the generative AI processing. Here, the veracity of the input data is specifically the veracity of the model, the veracity of the learning data, or the veracity of the input image (of the source data). That is, the veracity may be determined based on the degree to which the generation result by the model used for the processing of the generative AI is factual. The veracity may be determined based on the degree to which the learning data used for the processing of the generative AI is factual. Alternatively, the veracity may be determined based on the degree to which the source data used for the processing of the generative AI is factual. Furthermore, the veracity may be determined by combining a plurality of them. This can determine and record the information regarding the veracity regardless of the form of the information regarding the veracity.

### Sixth Embodiment

In the first embodiment to the fifth embodiment, an example in which the veracity or the information regarding the veracity is determined and recorded in the metadata of the generation result file has been described. On the other hand, in the present embodiment, a generation result file in which the veracity or the information regarding the veracity is embedded is recorded in a cloud environment. Then, an example in which the user acquires an image with a desired veracity with reference to the veracity or information regarding the veracity stored in the metadata in the generation result file recorded in the cloud environment will be described.

### Usage Form

The use case in the sixth embodiment will be described with reference to FIG. 13. FIG. 13 is a schematic diagram illustrating an example of a use case of the information processing apparatus in the sixth embodiment. In FIG. 13, the Inpainting image data 104 and the Inpainting image file 108 in which the veracity of the image is embedded are recorded in a cloud environment 1301 that is an environment different from the veracity recording apparatus 101.

### Configuration

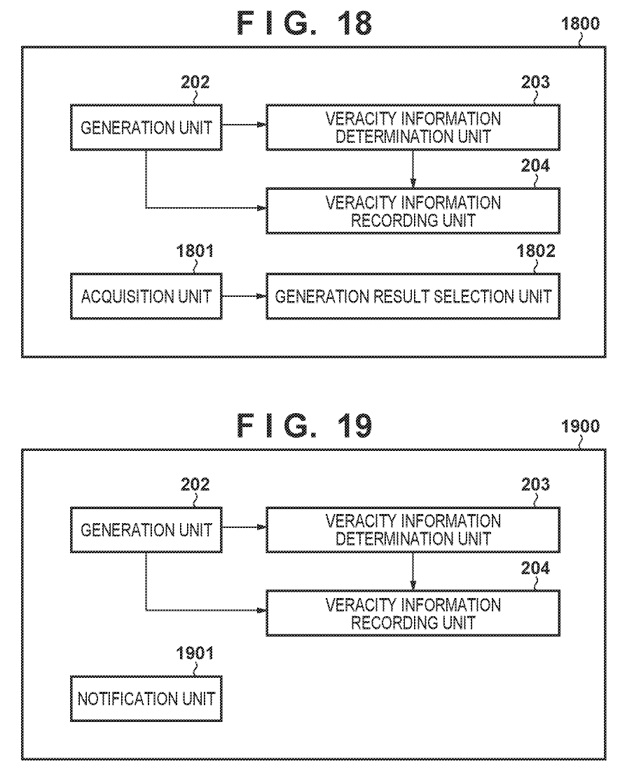

The configuration of the information processing apparatus according to the sixth embodiment will be described with reference to FIG. 18. An information processing apparatus 1800 according to the present embodiment includes an acquisition unit 1801 and a generation result selection unit 1802 in addition to the components of FIG. 2. Note that other components are similar to those of the above-described embodiments, and thus detailed description thereof will be omitted.

The acquisition unit 1801 acquires, from the user, input information that is information regarding the veracity requested by the user. The generation result selection unit 1802 selects a generation result of an appropriate veracity based on the information regarding the veracity requested by the user acquired by the acquisition unit 1801 and the veracity information recorded by the veracity information recording unit 204. Detailed selection processing will be described later.

### Processing Procedure and Detailed Method Of Processing

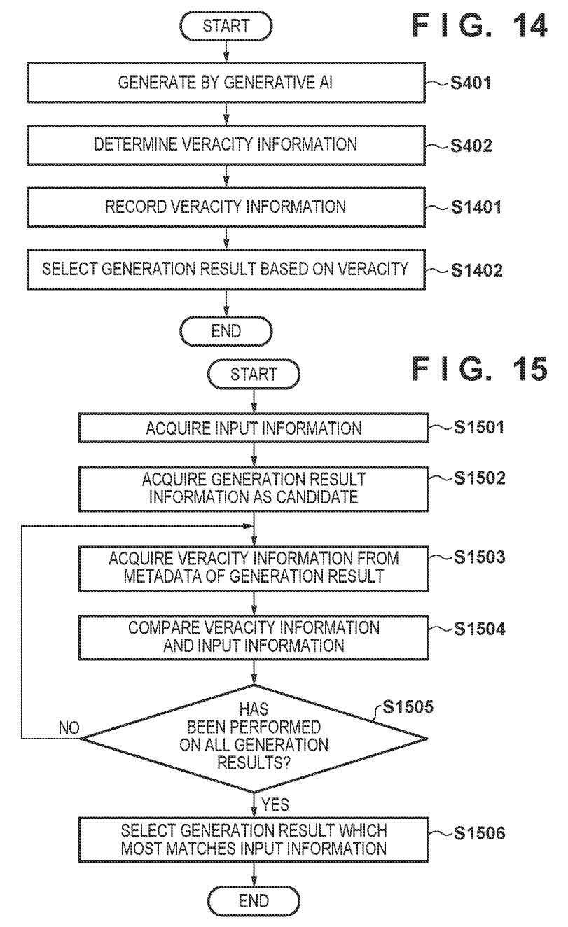

The processing procedure and the detailed method of processing of the information processing apparatus 201 according to the present embodiment will be described with reference to FIGS. 7, 14, and 15. FIG. 14 is a flowchart showing the flow of the entire processing to be executed by the information processing apparatus 201 in the present embodiment, similarly to the first embodiment to the fifth embodiment. In the present embodiment, step S1401 and step S1402 are newly added. Note that processing in steps S401 and S402 is similar to that in the first embodiment to the fifth embodiment, and thus description thereof will be omitted.

In step S1401, in the present embodiment, the veracity information recording unit 204 embeds, in the Inpainting image file 108, the veracity of the Inpainting image data 104 determined by the veracity information determination unit 203. Then, the Inpainting image file 108 is stored in the cloud environment 1301. Detailed processing other than recording into the cloud environment 1301 is similar to that in the other embodiments.

In step S1402, the acquisition unit 1801 acquires, from the user, input information that is information regarding the veracity requested by the user. The generation result selection unit 1802 selects a generation result of an appropriate veracity based on the information regarding the veracity requested by the user acquired by the acquisition unit 1801 and the veracity information recorded by the veracity information recording unit 204. Detailed description will be given later with reference to FIG. 15.

Next, a method of selecting a generation result based on the veracity in the present embodiment will be described with reference to FIG. 15. FIG. 15 is a flowchart showing the flow of detailed processing for selecting a generation result of an appropriate veracity to be performed in step S1402 of FIG. 14 in the present embodiment.

In step S1501, the acquisition unit 1801 acquires the input information. In the present embodiment, the input information is information regarding the veracity requested by the user. For example, the input information is text information of "generation result with the highest veracity". This input information is input by being selected by the user from among options of "generation result with the highest veracity", "generation result with the lowest veracity", and "generation result with a predetermined value of the veracity" presented to the user.

In step S1502, the generation result selection unit 1802 acquires, from the cloud environment 1301, generation result information serving as a selection candidate. In the present embodiment, a plurality of generation results stored in the cloud environment 1301 in which the veracity is recorded by the veracity information recording unit 204 are acquired.

In step S1503, the generation result selection unit 1802 acquires the veracity information from the metadata with respect to one of the plurality of generation results in which the veracity is recorded by the veracity information recording unit 204 acquired in step S1502.

In step S1504, the generation result selection unit 1802 compares the veracity of the generation result of the selection candidate acquired in step S1503 with the information (input information) regarding the veracity requested by the user acquired in step S1501. In the present embodiment, specifically, it is determined whether the veracity of the generation result of the selection candidate acquired in step S1503 most matches the input information among the veracity of all the candidate generation results compared so far. Then, in a case of being determined to most match, the generation result information is output. On the other hand, in a case of being determined not to most match, the generation result information most matching the input information so far is output.

In step S1505, the generation result selection unit 1802 determines whether the processing in steps S1503 and S1504 has been performed on all the candidate generation results. In a case where it has been performed on all the candidate generation results, the process transitions to step S1506. On the other hand, in a case where it has not been performed on all the candidate generation results, the process transitions to step S1503.

In step S1506, the generation result selection unit 1802 selects and outputs the generation result whose veracity most matches the input information acquired in step S1501 from among all the candidate generation results.

### Effect

As described above, according to the present embodiment, it is possible for the user to acquire an image with a desired veracity with reference to the veracity or the information regarding the veracity stored in the metadata of the generation result file recorded in an apparatus other than the information processing apparatus.

### Modification: Variation of Method of Selecting Generation Result

In the sixth embodiment, the veracity information described in the first embodiment to the fourth embodiment is recorded in the generation result file, and an appropriate generation result is selected based on the recorded veracity. However, the present disclosure is not limited to this, and the generation result may be selected based on other information as long as an appropriate generation result can be selected.

For example, as described in the fifth embodiment, when the prompt information is recorded in the generation result file, an appropriate generation result may be selected based on the prompt information. In this case, it is possible to select an appropriate generation result by estimating the veracity from the content of the prompt information recorded in the metadata and comparing the veracity thereof with the input information. A specific method of determining the content of the prompt information at this time may be determination by a user operation. Alternatively, the determination may be made using a result of character recognition by a known optical character recognition (OCR) technology. This can select an appropriate generation result regardless of the form of the veracity information or the information regarding the veracity recorded in the generation result file.

### Modification: Variation of Recording Environment

In the sixth embodiment, the generation result file in which the veracity is embedded is stored in the cloud environment 1301, but it may be the same hardware apparatus as the information processing apparatus 201 as long as the generation result file in which the veracity is embedded can be stored. The generation result file may be stored in an edge server such as a DB. This can select an appropriate generation result regardless of the form of the hardware of the storage destination of the generation result file in which the veracity is embedded.

### Modification: DB Management of Veracity

In the sixth embodiment, the generation result file in which the veracity is embedded is stored in the cloud environment 1301, but the veracity may be recorded by a method other than the form of embedding in the file as long as the veracity is recorded in a state of being associated with the generation result file.

For example, the veracity and the generation result file may be recorded in a database of a cloud. In this case, the generation result file is stored in the cloud, and the file name or the file ID and the veracity are recorded in association with each other in the database. In this case, for example, in step S1503 of FIG. 15, the veracity of the generation result file is referred to from the database with the file name or the file ID of the generation result file of which the veracity is to be referred to as a key. By doing so, even in a case where it is difficult to embed the veracity into the generation result file, the veracity of the generation result file can be recorded and the veracity of the generation result file can be referred to.

Note that an embodiment in which the generation result file and the veracity are recorded in a database of a cloud has been described here, but the database may be constructed not only in the cloud but also in a local PC or an on-premises server.

### Seventh Embodiment

In the sixth embodiment, an example of selecting an appropriate generation result matching the user request with reference to the veracity recorded in the generation result file has been described. On the other hand, in the present embodiment, a method of notifying the user of the control content implemented in the first to sixth embodiments will be described. Specifically, the generation result file in which the veracity is embedded is recorded in the cloud environment, and the recorded content is displayed on a display screen.

### Usage Form

The use case in the seventh embodiment is similar to the use case in the sixth embodiment, and thus the description thereof will be omitted.

### Configuration

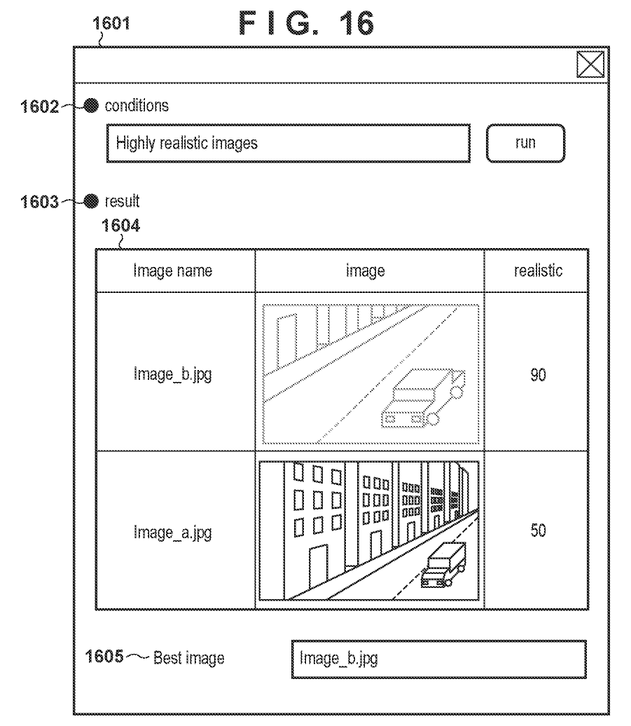

A system configuration according to the seventh embodiment will be described with reference to FIGS. 19 and 16. An information processing apparatus 1900 according to the present embodiment includes a notification unit 1901 in addition to the components of FIG. 2. Note that other components are similar to those of the above-described embodiments, and thus detailed description thereof will be omitted. The notification unit 1901 notifies of the generation results in order according to the veracity based on the processing result of at least one of the generation unit 202, the veracity information determination unit 203, and the veracity information recording unit 204.

FIG. 16 is a view illustrating a display screen of a processing result of a usage form described in the first embodiment as an example of the notification unit according to the sixth embodiment. A confirmation condition setting unit 1602 of a display screen 1601 is a screen for inputting a display condition for displaying a generation result file and the veracity recorded in the generation result file. In FIG. 16, the content of "display a generated image with high veracity" is described as a display condition.

A result display unit 1603 displays the processing result of at least one of the generation unit 202, the veracity information determination unit 203, and the veracity information recording unit 204 according to the condition set by the confirmation condition setting unit 1602. Here, a result list 1604 displays a list of generated image names, generated image data, and the veracity associated with the image data. Then, as set by the confirmation condition setting unit 1602, the list is displayed with the veracity sorted in descending order. In the present embodiment, the generated image and the veracity to be displayed here are displayed by acquiring the generation result file stored in the cloud environment 1301 and reading the veracity recorded in the metadata of the file. In the result list 1604 of FIG. 16, the name of the super-resolution image data 106 of "Image_b.jpg", the image data thereof, and the numerical value of "90" as the veracity are displayed at the top of the list. It is indicated that the super-resolution image data 106 displayed at the top is the generation result with the highest veracity. The result most matching the condition "the generation result with the highest veracity" is displayed on a display unit 1605.

### Effect

As described above, according to the present embodiment, the plurality of generation results are notified in the arrangement order according to the veracity. That is, it is possible to notify the user of the control content and the result thereof recorded by determining the veracity of the generation result by the generative AI so as to enable confirmation.

### Modification: Variation of Display Content

In the present embodiment, the content of displaying, in the result list, the generation result image data, the file name thereof, and the veracity stored in the image file described in the first embodiment has been described, but other content may be displayed as long as the control result of the information processing apparatus 201 can be displayed.

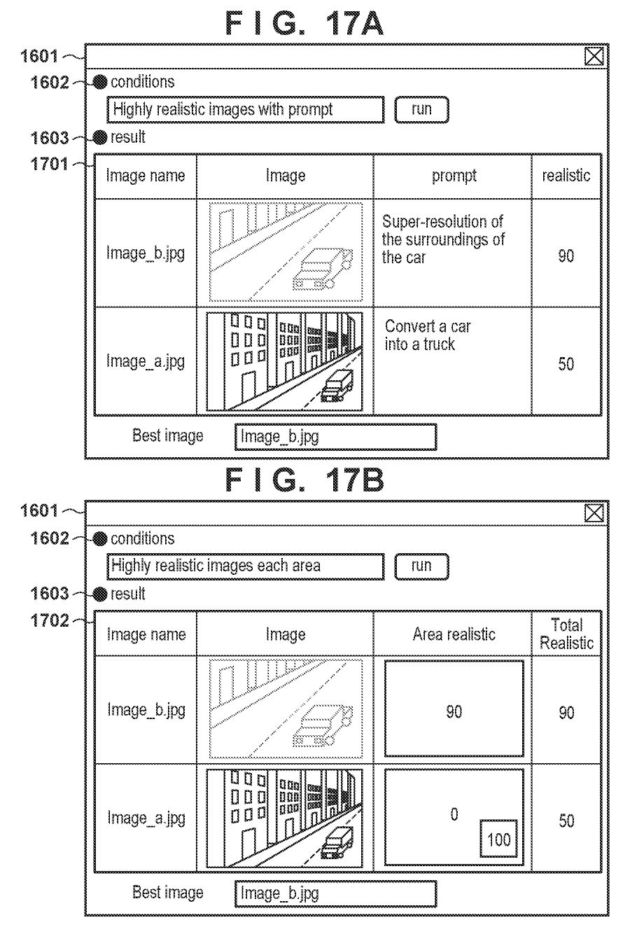

For example, FIG. 17A illustrates display of the control result of the fifth embodiment. In the display screen 1601 of FIG. 17A, the confirmation condition setting unit 1602 describes a display condition of "display a generated image with a high veracity and prompt content thereof". A result list 1701 of the result display unit 1603 at this time displays an information list including generated image names, generated image data, the content of the prompt recorded in the metadata of the generated image file, and the veracity estimated from the prompt content thereof.

For example, the content of the prompt at the top displays "super-resolution around the vehicle" that is prompt content of the super-resolution image data 106. Based on this prompt content, "90" is displayed in the field of the veracity as the veracity determined using the result of character recognition by a known optical character recognition (OCR) technology.

FIG. 17B illustrates the control result of the second embodiment. In the display screen 1601 of FIG. 17A, the confirmation condition setting unit 1602 describes a display condition of "display generated image content with high entire veracity and the veracity for each partial region". A result list 1702 of the result display unit 1603 at this time displays a list of generated image names, generated image data, the veracity information for each partial region recorded in the metadata of the generated image file, and the entire veracity. Here, the mean value of the veracity for each partial region is displayed as the entire veracity, but a value of the entire veracity obtained by another method may be displayed as long as the veracity of the entire image can be displayed. For example, a sum of values in which the veracity of each partial region is multiplied by the area ratio with the area ratio of the partial region as a weight may be used as the entire veracity.

This can display the determination of the veracity and the recording result thereof, and therefore the user can easily perform confirmation.

According to the present disclosure, it is possible to confirm how much the generation result remains unchanged with respect to the source data. Therefore, it is possible to confirm how factual a generation result by generative AI is.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-156835, filed September 10, 2024, which is hereby incorporated by reference herein in its entirety.

What is claimed is:

1. An information processing apparatus comprising:
a generation unit configured to acquire a generation result from source data using generative AI;
a determination unit configured to determine information indicating a degree to which the generation result remains unchanged with respect to the source data based on information on the generative AI; and
a recording unit configured to record the generation result and the information determined by the determination unit in association with each other.

2. The information processing apparatus according to claim 1, wherein the determination unit determines, as the information indicating the degree, information associated in advance with model information on the generative AI.

3. The information processing apparatus according to claim 1, wherein the determination unit determines, as the information indicating the degree, a ratio of a region not edited by the generative AI to an entire region of the source data.

4. The information processing apparatus according to claim 1, wherein the determination unit determines, as the information indicating the degree, similarity between the source data and the generation result.

5. The information processing apparatus according to claim 1, wherein the determination unit determines the information indicating the degree based on a setting parameter of a reflection rate of a prompt used for processing of the generative AI.

6. The information processing apparatus according to claim 1, wherein the determination unit determines the information indicating the degree based on at least one of a degree to which a generation result by a model used for processing of the generative AI is factual, a degree to which learning data used for processing of the generative AI is factual, and a degree to which source data used for processing of the generative AI is factual.

7. The information processing apparatus according to claim 1, wherein the determination unit determines the information indicating the degree based on a setting parameter value set in processing of the generative AI and determining an editing amount by processing of the generative AI.

8. The information processing apparatus according to claim 1, wherein the recording unit records, in association with the information indicating the degree, at least one piece of supplementary information among time information at which processing by the generative AI was executed, an execution history of processing by the generative AI, and information indicating a determination basis or a definition of the information indicating the degree.

9. The information processing apparatus according to claim 1, wherein the generation result is information of an image, a moving image, or an audio.

10. The information processing apparatus according to claim 1, wherein the determination unit determines the information indicating the degree for an entire region of the generation result, and determines the information indicating the degree for each partial region of the generation result.

11. The information processing apparatus according to claim 1, wherein the recording unit records the information indicating the degree in metadata of the generation result.

12. The information processing apparatus according to claim 1, wherein
the generation result includes image data, and
the recording unit records the information indicating the degree in an extension channel of the image data.

13. The information processing apparatus according to claim 1, wherein the recording unit encrypts and records at least one of the information indicating the degree and supplementary information on the information.

14. The information processing apparatus according to claim 1 further comprising:
an acquisition unit configured to acquire a request by a user; and
a selection unit configured to select a generation result matching the request by the user from a plurality of generation results.

15. The information processing apparatus according to claim 1 further comprising
a notification unit configured to notify of the generation result and the information indicating the degree, wherein
the notification unit notifies of a plurality of generation results in an arrangement order according to the degree.

16. An information processing apparatus comprising:
a generation unit configured to acquire a generation result using generative AI;
a determination unit configured to determine information indicating a degree to which the generation result is factual, based on information on the generative AI; and
a recording unit configured to record the generation result and the information determined by the determination unit in association with each other.

17. A method of controlling an information processing apparatus, the method comprising:
acquiring a generation result from source data using generative AI;
determining information indicating a degree to which the generation result remains unchanged with respect to the source data based on information on the generative AI; and
recording the generation result and the information determined by the determining in association with each other.

18. A method of controlling an information processing apparatus, the method comprising:
acquiring a generation result using generative AI;
determining information indicating a degree to which the generation result is factual, based on information on the generative AI; and
recording the generation result and the information determined by the determining in association with each other.

19. A storage medium storing a program for causing a computer to execute a method of controlling an information processing apparatus, the method including:
acquiring a generation result from source data using generative AI;
determining information indicating a degree to which the generation result remains unchanged with respect to the source data based on information on the generative AI; and
recording the generation result and the information determined by the determining in association with each other.

20. A storage medium storing a program for causing a computer to execute a method of controlling an information processing apparatus, the method including:
acquiring a generation result using generative AI;
determining information indicating a degree to which the generation result is factual, based on information on the generative AI; and
recording the generation result and the information determined by the determining in association with each other.
